(19) United States
(12) Patent Application Publication
(10) Pub. No.: US 2010/0257458 A1
(43) Pub. Date: Oct. 7, 2010

(54) METHOD AND SYSTEM FOR USING MESSAGE SERVICES FOR CONTROL AND INTERACTION IN CONTENT DISTRIBUTION

(76) Inventors: Gregory Charles Herlein, San Francisco, CA (US); Scott Francis, Danville, CA (US); Vincent E. Sartor, Benicia, CA (US)

Correspondence Address: Robert D. Shedd, Patent Operations;THOMSON Licensing LLC, P.O. Box 5312, Princeton, NJ, 08543-5312, US

(21) Appl. No.: 12/734,729

(22) PCT Filed: Nov. 18, 2008
(86) PCT No.: PCT/US2008/012885

§ 371 Date: May 19, 2010

Related U.S. Application Data
(60) Provisional application No. 61/003,634, filed on Nov. 19, 2007.

(51) Int. Cl. G06F 15/16; G06F 11/07; G06F 3/048; G06Q 30/00

(52) U.S. Cl. 715/752; 709/206; 714/57; 705/14.4; 714/E11.025

(57) ABSTRACT

A method for using a message service for communication in a content distribution environment includes soliciting a response from a user where the user is instructed to respond using a message service and an advertised point of contact. In response to a received message, an action associated with the received message is initiated and the location for execution of the initiated action is identified using the point of contact information communicated by the user. In circumstances in which shoppers have text-message enabled cell phones, a shopper can be solicited, in a display presenting content, to text a message to an identified point of contact for additional related content. A play-out system can then play the requested additional content on a display in close proximity to the shopper, where the display is identified using the point of contact information communicated by the user in the message.

### CROSS-REFERENCE TO RELATED APPLICATIONS

This application claims the benefit of U.S. Provisional Application No. 61/003,634, filed Nov. 19, 2007.

### FIELD OF THE INVENTION

The present invention generally relates to communication methods within content distribution environments and systems and, more particularly, to a method, apparatus and system for using message services for control and interaction within a content distribution environment.

### BACKGROUND OF THE INVENTION

Information and content distribution systems are used to provide information and content to a plurality of end systems. For example, in the advertising realm, providing in-store retail media content is becoming the most popular advertising medium in use today, with broadcast distribution being its primary means of content presentation. That is, in recent years retailers and the managers of public spaces have brought in video display systems for advertising use. In such systems, content is distributed by a server and received at receivers such as a respective set-top-box for each display or group of displays and associated speakers. Retailers use the displays and speakers to present their current offerings or sale information, while the public spaces sell time on the video displays and speakers to advertisers either national or local, knowing that large numbers of consumers will see the presentation.

In such systems, at the site of a media playback system there is not a simple way to access the control and configuration settings while in a position to be able to hear/see the video and audio. That is, the video screens and speakers are distributed across a large area, and the server running them typically is locked in a back room, or located at a remote location. Typically, in current systems such control is provided by phone calls to a help desk or by using a hidden push button on a display. A large percentage of the calls to the help desk are for simple volume adjustments that users viewing the video or hearing the audio are unable to make without remote assistance.

Another common problem of such current advertising systems is attempting to match the video playing on an end-cap with the product that is actually displayed. In current systems, a user or installer typically pushes a button to loop through a list of available media one at a time to match advertising with available product. In addition, installers must verify that all parts of the system are connected and functioning properly and in current systems there is no way to do this without calling the help desk.

### SUMMARY OF THE INVENTION

Embodiments of the present invention address the deficiencies of the prior art by providing a method, apparatus and system for using message services, such as short-message service or multimedia-message-service (SMS/MMS) messages, for control and interaction within a content distribution environment.

In an embodiment of the present invention, a method for using a message service for communication in a content distribution environment includes soliciting a response from a user, the user instructed to respond using a message service and an advertised point of contact and in response to a received message, initiating an action associated with the received message. The method further includes identifying a location for execution of the initiated action using the point of contact information communicated by the user.

In an alternate embodiment of the present invention, a system for using a message service for communication in a content distribution environment includes at least one display for displaying content, at least one communication means for communicating messages using a message service, and a server. In such an embodiment of the present invention, the server is configured to perform the steps of soliciting a response from a user, the user instructed on at least one display to respond using at least one communication means via the message service and an advertised point of contact and, in response to a received message, initiating an action associated with the received message, wherein the location for execution of the initiated action is identified using the point of contact information communicated by the user.

### BRIEF DESCRIPTION OF THE DRAWINGS

The teachings of the present invention can be readily understood by considering the following detailed description in conjunction with the accompanying drawings, in which:

FIG. 1 depicts a high level block diagram of a content distribution system and a mobile communications system in which an embodiment of the present invention can be applied;

FIG. 2 depicts a high level block diagram of an in-store advertising network for providing in-store advertising in accordance with an embodiment of the present invention;

FIG. 3 depicts an example sequence diagram for using message services for two-way messaging in a content distribution environment in accordance with an embodiment of the present invention;

FIG. 4 depicts a high level block diagram of a content distribution system in accordance with an alternate embodiment of the present invention; and

FIG. 5 depicts a flow diagram of a method for using message service for control and interaction in a content distribution environment in accordance with an embodiment of the present invention.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF THE INVENTION

The present invention advantageously provides a method, apparatus and system for using message services, such as SMS/MMS messages, for control and interaction within a content distribution environment. Although the present invention will be described primarily within the context of a retail advertising network environment using short-message service or multimedia-message-service (SMS/MMS) messages, the specific embodiments of the present invention should not be treated as limiting the scope of the invention. It will be appreciated by those skilled in the art and informed by the teachings of the present invention that the concepts of the present invention can be advantageously applied in substantially any content distribution environment using other communications means such as Bluetooth.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The various embodiments of the present invention include using message services, such as short-message service or multimedia-message-service (SMS/MMS) messaging, such that a user can send requests to an automated system, and receive detailed responses. For example, shoppers often have text-message enabled cell phones. In accordance with embodiments of the present invention, an advantageous way to interact with the shopper is to ask them in the ad to text a message for more information. A playout system or device can then play an ad based on that information and can send the shopper text messages back. This interaction model can engage a user at a deeper level.

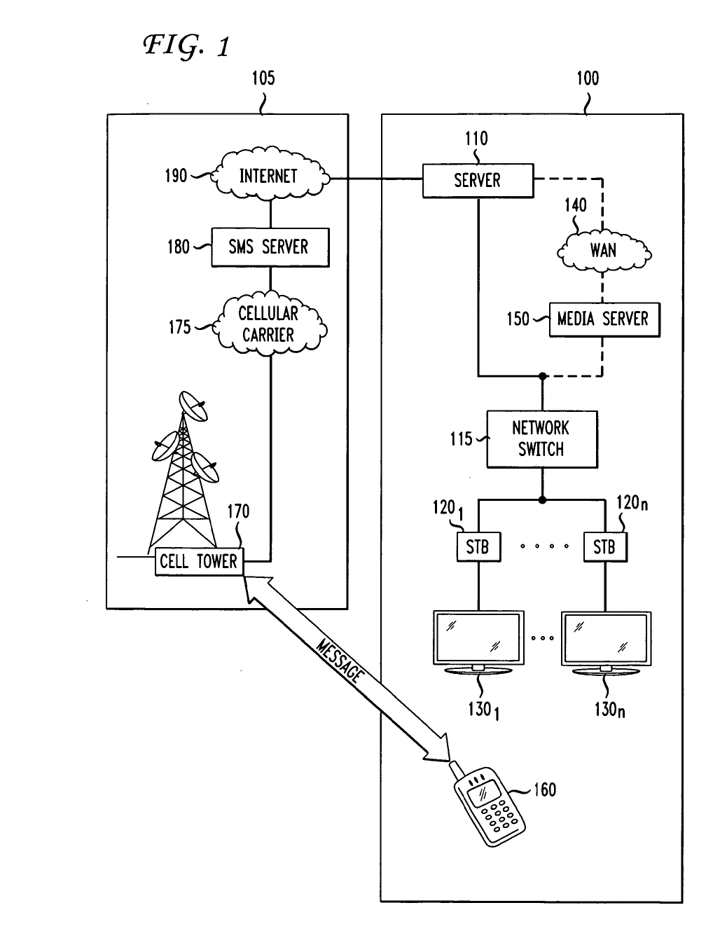

FIG. 1 depicts a high level block diagram of a content distribution system 100 and a mobile communications system 105 in which an embodiment of the present invention can be applied. The content distribution system 100 of FIG. 1 illustratively comprises at least one server 110, a switch 115 (illustratively a network switch), a plurality of receiving devices such as tuning/decoding means (illustratively set-top boxes (STBs)) 120₁-120ₙ, and a respective display 130₁-130ₙ for each of the set-top boxes 120₁-120ₙ. The content distribution system 100 of FIG. 1 further includes an optional wide-area-network (WAN) 140, an optional media server 150 and a mobile communications device 160 (illustratively a mobile phone).

Although in the system 100 of FIG. 1, each of the plurality of set-top boxes 120₁-120ₙ, is illustratively connected to a single, respective display, in alternate embodiments of the present invention, each of the plurality of set-top boxes 120₁-120ₙ, can be connected to more than a single display. In addition, although in the content distribution system 100 of FIG. 1 the tuning/decoding means are illustratively depicted as set-top boxes 120, in alternate embodiments of the present invention, the tuning/decoding means of the present invention can comprise alternate tuning/decoding means such as a tuning/decoding circuit integrated into the displays 130 or other stand alone tuning/decoding devices and the like. Even further, receiving devices of the present invention can include any devices capable of receiving content such as text, audio, video and/or audio/video content.

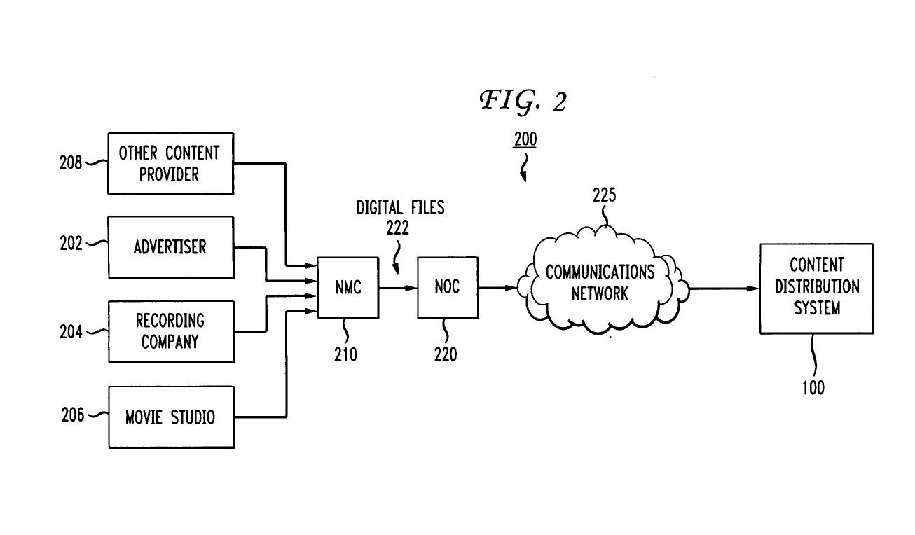

In one embodiment of the present invention, the content distribution system 100 of FIG. 1 can be a part of an in-store advertising network. For example, FIG. 2 depicts a high level block diagram of an in-store advertising network 200 for providing in-store advertising. In the advertising network 200 of FIG. 2, the advertising network 200 and distribution system 100 employ a combination of software and hardware that provides cataloging, distribution, presentation, and usage tracking of music recordings, home video, product demonstrations, advertising content, and other such content, along with entertainment content, news, and similar consumer informational content in an in:store setting. The content can include content presented in compressed or uncompressed video and audio stream format (e.g., MPEG2, MPEG4/MPEG4 Part 10/AVC-H.264, VC-1, Windows Media, etc.), although the present system should not be limited to using only those formats.

In one embodiment of the present invention, software for controlling the various elements of the in-store advertising network 200 and the content distribution system 100 can include a 32-bit operating system using a windowing environment (e.g., MS-Windows™ or X-Windows operating system) and high-performance computing hardware. The advertising network 200 can utilize a distributed architecture and provides centralized content management and distribution control via, in one embodiment, satellite (or other method, e.g., a wide-area network (WAN), the Internet, a series of microwave links, or a similar mechanism) and in-store modules.

As depicted in FIG. 2, the content for the in-store advertising network 200 and the content distribution system 100 can be provided from an advertiser 202, a recording company 204, a movie studio 206 or other content providers 208. An advertiser 202 can be a product manufacturer, a service provider, an advertising company representing a manufacturer or service provider, or other entity. Advertising content from the advertiser 202 can consist of audiovisual content including commercials, “info-mercials”, product information and product demonstrations, and the like.

A recording company 204 can be a record label, music publisher, licensing/publishing entity (e.g., BMI or ASCAP), individual artist, or other such source of music-related content. The recording company 204 provides audiovisual content such as music clips (short segments of recorded music), music video clips, and the like. The movie studio 206 can be a movie studio, a film production company, a publicist, or other source related to the film industry. The movie studio 106 can provide movie clips, pre-recorded interviews with actors and actresses, movie reviews, “behind-the-scenes” presentations, and similar content.

The other content provider 208 can be any other provider of video, audio or audiovisual content that can be distributed and displayed via, for example, the content distribution system 100 of FIG. 1.

In one embodiment of the present invention, content is procured via the network management center 210 (NMC) using, for example, traditional recorded media (tapes, CD's, videos, and the like). Content provided to the NMC 210 is compiled into a form suitable for distribution to, for example, the local distribution system 100, which distributes and displays the content at a local site.

The NMC 210 can digitize the received content and provide it to a Network Operations Center (NOC) 220 in the form of digitized data files 222. It will be noted that data files 222, although referred to in terms of digitized content, can also be streaming audio, streaming video, or other such information. The content compiled and received by the NMC 210 can include commercials, bumpers, graphics, audio and the like. All files are preferably named so that they are uniquely identifiable. More specifically, the NMC 210 creates distribution packs that are targeted to specific sites, such as store locations, and delivered to one or more stores on a scheduled or on-demand basis. The distribution packs, if used, contain content that is intended to either replace or enhance existing content already present on-site (unless the site's system is being initialized for the first time, in which case the packages delivered will form the basis of the site's initial content). Alternatively, the files may be compressed and transferred separately, or a streaming compression program of some type employed.

The NOC 220 communicates digitized data files 222 to, in this example, the content distribution system 100 at a commercial sales outlet 230 via a communications network 225. The communications network 225 can be implemented in any one of several technologies. For example, in one embodiment of the present invention, a satellite link can be used to distribute digitized data files 222 to the content distribution system 100 of the commercial sales outlet 230. This enables content to easily be distributed by broadcasting (or multicasting) the content to various locations. Alternatively, the Internet can be used to both distribute audiovisual content to and allow feedback from commercial sales outlet 230. Other ways of implementing communications network 225, such as using leased lines, a microwave network, or other such mechanisms can also be used in accordance with alternate embodiments of the present invention.

Referring back to FIG. 1, the server 110 of the content distribution system 100 is capable of receiving content (e.g., distribution packs) and, accordingly, distribute them in-store to the various receivers such as the set-top boxes 120 and displays 130. That is, at the content distribution system 100, content is received and configured for streaming. The streaming can be performed by one or more servers configured to act together or in concert. The streaming content can include content configured for various different locations or products throughout the sales outlet 230 (e.g., store). For example, respective set-top boxes 120 and displays 130 can be located at specific locations throughout the sales outlet 230 and respectively configured to display content and broadcast audio pertaining to products located within a predetermined distance from the location of each respective set-top box and display.

The server 110 of the content distribution system 100 receives content and creates various different streams (e.g., content channels) of text, audio, video and/or audio/video to be communicated to the various receivers throughout the store. The streams can be individual channels of text, modulated audio, video and/or audio/video onto a radio frequency distribution or transmitted as data flows within a unicast or multicast internet protocol (IP) network. These streams can originate from one or more servers under the same logical set of control software.

Referring back to FIG. 1, the mobile communication system 105 of FIG. 1 illustratively comprises a cell tower 170, a cellular carrier 175, a message server 180 (illustratively an SMS server) and an Internet 190. In the embodiment of FIG. 1, a user can communicate messages, such as SMS/MMS messages in the form of text messages, using the mobile communications device 160 via the mobile communication system 105 of FIG. 1. More specifically, the messages from the mobile communications device 160 are received by, for example, the cell tower 170 of FIG. 1 and are then communicated to the cellular carrier 175. At the cellular carrier 175, the message server 180 configures the messages for transmission and communicates the received messages over the internet 190 to the server 110 of the content distribution system 100 of FIG. 1. That is, the message server 180 encapsulates the SMS/MMS text in an internet protocol message. That message is transmitted to the server 110. The server 110 processes the message and decides what to do as will be described in further detail below.

In one embodiment of the content distribution system 100 of FIG. 1 in which the server 110, as described above, creates various different streams (e.g., content channels) of text, audio, video and/or audio/video to be communicated to the various receivers throughout the store, and is the central control point for content distribution and control and also delivers local over-rides to the stores and is the central log collection and health status collection point for a set of stores, the server 110 responds to a message sent from the mobile communications device 160 over the mobile communication system 105 with an appropriate response, which will be described in greater detail below. That is, the server 110 communicates an appropriate response to the mobile communications device 160 by causing the display of the response on a display 130 in the proximity of the mobile communications device which transmitted the message received by the server 110. For example, in one embodiment of the present invention, a display 130 in proximity of a user communicating a message can be identified, for example, by the number that was used by a user to communicate a message. That is, in one embodiment of the present invention, each display or group of displays can be assigned a unique number to display to a user for use by a user for messaging in accordance with the present invention. As such, a location of a display can be identified and as such the location of a user communicating a message in accordance with the present invention can be identified. Alternatively, in an alternate embodiment of the present invention, each display or group of displays can be identified by a code displayed by each display and which a user has to include in a message for use in identification of the location of a display and as such a user.

In an alternate embodiment of the content distribution system 100 of FIG. 1 which includes a local WAN 140 and a media server 150, the media server 150 typically delivers local over-rides to the stores and is the central log collection and health status collection point for a set of stores. The media server 150 is also typically the location where the configuration settings for stores are cached. In such an embodiment, the server 110 processes the received message and communicates the message over the WAN 140 to the media server 150. The communicated message directs the media server 150 to take an appropriate action in response to the received message.

One simple example of an interaction capable with the messaging capabilities of the present invention includes a shopper that sees a message on a display in proximity that displays an advertisement that instructs the shopper to send a text message to a specified number for more information on an advertised product. In response to the instructions, the shopper can send a text message to the identified number using, for example, a mobile communications device and, in response, the shopper can be presented additional content on the same or an alternate display in the proximity of the customer.

In an alternate embodiment of the present invention, the messaging capabilities of the present invention can be used by a technician for configuration purposes, verification of installation or for trouble shooting. For example, if a technician wishes to communicate and interact with an appropriate server, a message can be communicated to the server and the server can respond with a failure code if any error occurs during processing of the request. All successful interactions are sent a code verifying that the action was performed. Some typical interactions that are possible with the messaging capabilities of the present invention can include:
1. Installation certification—When an installer believes an installation to be complete they issue this request. The system messages back an okay, or a list of problems that need to be corrected.
2. Configuration changes—For example, volume adjustments; It is a constant effort to be sure that volume levels are correct in each viewing area. Temporary and permanent volume adjustments are required. SMS messages can be used to adjust volume. For example, playout characteristics; Using predetermined commands, a user can change characteristics of a playout device by communicating with the playout device using messaging capabilities of the present invention.
3. Playlist modification—For example, changing the media playing on an end-cap to match an actual product displayed. SMS messages can be used to select the proper media.
4. Operational Mode Change—There are several modes available to allow volume adjustments, verify screen locations, test components, channel selection, media selection, etc. Each operational mode can have a keyword assigned to it, so that any available mode can be selected.
5. Text display—If a video display has the ability to display text, then the SMS text message can be sent directly to a display.
6. Picture Display—If a video display has the ability to display a still picture, then the MMS message with an embedded picture can be sent directly to a display.
7. Content Display—A user can capture content with a mobile communications device and the content can be presented as part of a display.

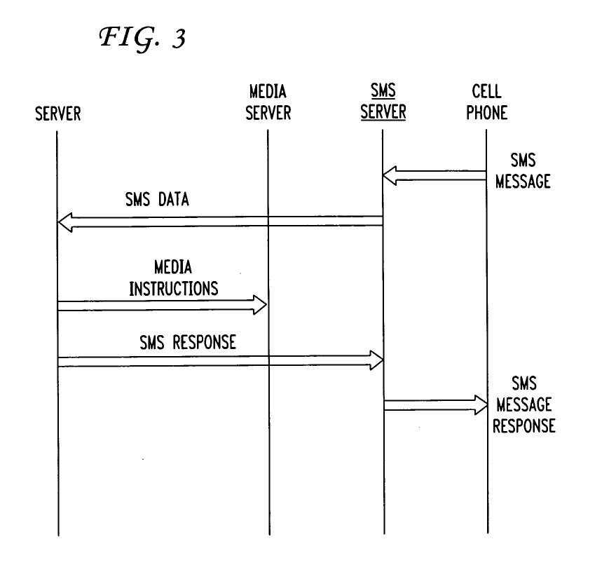

In accordance with various embodiments of the present invention, optionally a message can be sent from a server back to a mobile communication device from which a message was received. For example, FIG. 3 depicts an example sequence diagram for using message services for two-way messaging in a content distribution environment in accordance with an embodiment of the present invention. As depicted in FIG. 3, a message of the present invention can be communicated from a mobile communication device, illustratively a cell phone, to a message server, illustratively an SMS message server. The SMS message server communicates the SMS data to a server of, for example, a content distribution system of a retail store. The server processes the received message data and communicates control information to a media server at which the communicated message directs the media server to take an appropriate action in response to the received message, which can include the display, replacement or addition of content or messages in response to the received message. In the embodiment of FIG. 3, the server can additionally communicate a message response in the form of, for example an SMS message, to the SMS message server for communication to the user cell phone for communicating a message to a user.

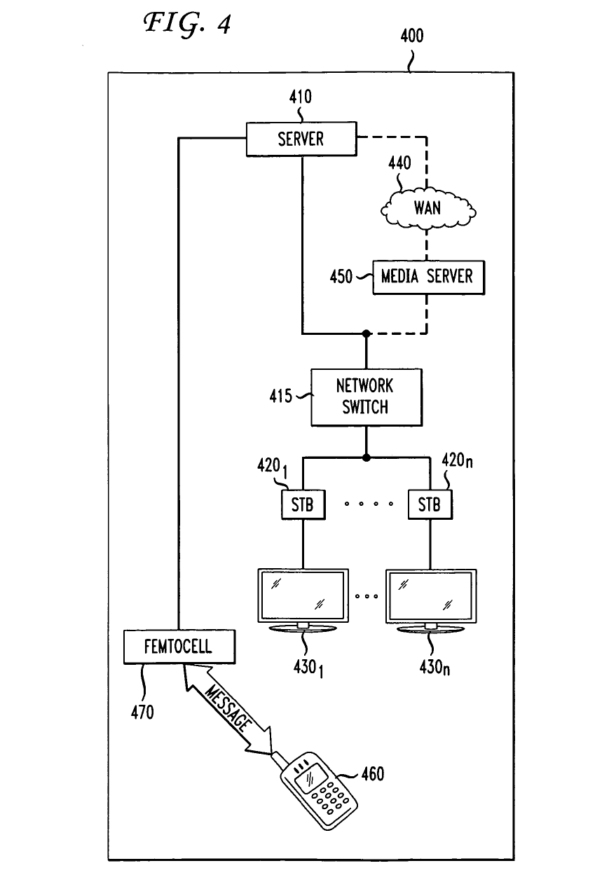

FIG. 4 depicts a high level block diagram of a content distribution system 400 in accordance with an alternate embodiment of the present invention. The content distribution system 400 of FIG. 4 illustratively comprises at least one server 410, a switch 415 (illustratively a network switch), a plurality of receiving devices such as tuning/decoding means (illustratively set-top boxes (STBs)) 420₁-420ₙ, and a respective display 430₁-430ₙ for each of the set-top boxes 420₁-420ₙ. The content distribution system 400 of FIG. 4 further illustratively includes an optional wide-area-network (WAN) 440, an optional media server 450, a mobile communications device 460 (illustratively a cell phone) and a means 470 for distribution of a signal from the communications device 460 (illustratively a Femtocell).

Although in the system 400 of FIG. 4, each of the plurality of set-top boxes 420₁-420ₙ, is illustratively connected to a single, respective display, in alternate embodiments of the present invention, each of the plurality of set-top boxes 420₁-420ₙ, can be connected to more than a single display. In addition, although in the content distribution system 400 of FIG. 4 the tuning/decoding means are illustratively depicted as set-top boxes 420, in alternate embodiments of the present invention, the tuning/decoding means of the present invention can comprise alternate tuning/decoding means such as a tuning/decoding circuit integrated into the displays 430 or other stand alone tuning/decoding devices and the like. Even further, receiving devices of the present invention can include any devices capable of receiving content such as text, still images, audio, video and/or audio/video content. Furthermore, although in the content distribution system 400 of FIG. 4 the means 470 for distribution illustratively comprises a Femtocell, in alternate embodiments of the present invention, the means 470 for distribution can include other signal distribution means such as wireless networking (802.11 and similar), BlueTooth™ networking, or other radio frequency or wireless technologies where messages are exchanged across a transport medium.

In the content distribution system 400 of FIG. 4, a user can communicate messages, such as SMS/MMS messages in the form of text messages, using the mobile communications device 460 via the a means 470 for distribution of FIG. 4. More specifically, the messages from the mobile communications device 460 are received by, for example, the Femtocell 470 of FIG. 4 and are then communicated to the server 410. The server 410 processes the message and decides what to do as described above with respect to the embodiment of FIG. 1.

The Femtocell 470 of FIG. 4 operates similar to the mobile communication system 105 of FIG. 1 but has the advantage that the time it takes to deliver a message is shorter than if it was routed through the mobile communication system 105. In one case, the message is immediately translated to an IP message and processed directly. While functionally similar, this method has a faster response time. Although the content distribution system 400 of FIG. 4 illustratively includes only one Femtocell 470, in alternate embodiments of the present invention, more than one Femtocell can be used in accordance with various alternate embodiments of the present invention.

In one embodiment of the content distribution system 400 of FIG. 4 in which the server 410 creates various different streams (e.g., content channels) of text, audio, video and/or audio/video to be communicated to the various receivers throughout the store, and is the central control point for content distribution and control and also delivers local over-rides to the stores and is the central log collection and health status collection point for a set of stores, the server 410 responds to a message sent from the mobile communications device 460 with an appropriate response as described above. That is, the server 410 communicates an appropriate response to the mobile communications device 460 by causing the display of the response on a display 430 in the proximity of the mobile communications device which transmitted the message received by the server 410. For example, in one embodiment of the present invention, a display 130 in proximity of a user communicating a message can be identified, for example, by the number that was used by a user to communicate a message. That is, in one embodiment of the present invention, each display or group of displays can be assigned a unique number to display to a user for use by a user for messaging in accordance with the present invention. As such, a location of a display can be identified and as such the location of a user communicating a message in accordance with the present invention can be identified. Alternatively, in an alternate embodiment of the present invention, each display or group of displays can be identified by a code displayed by each display and which a user has to include in a message for use in identification of the location of a display and as such a user.

In an alternate embodiment of the content distribution system 400 of FIG. 4 which includes a local WAN 440 and a media server 450, the media server 450 typically delivers local over-rides to the stores and is the central log collection and health status collection point for a set of stores. As described above, the media server 450 is also typically the location where the configuration settings for stores are cached. In such an embodiment, the server 410 processes the received message and communicates the message over the WAN 440 to the media server 450. The communicated message directs the media server 450 to take an appropriate action in response to the received message.

As described above, a simple example of an interaction capable with the messaging capabilities of the invention of FIG. 4 includes a shopper that sees a message on a display in proximity that displays an advertisement that instructs the shopper to send a text message to a specified number for more information on an advertised product. In response to the instructions, the shopper can send a text message to the identified number using, for example, a mobile communications device and, in response, the shopper can be presented additional content on the same or an alternate display in the proximity of the customer.

Similarly, as described above, in an alternate embodiment of the present invention, the messaging capabilities of the present invention can be used by a technician for configuration purposes, verification of installation or for trouble shooting.

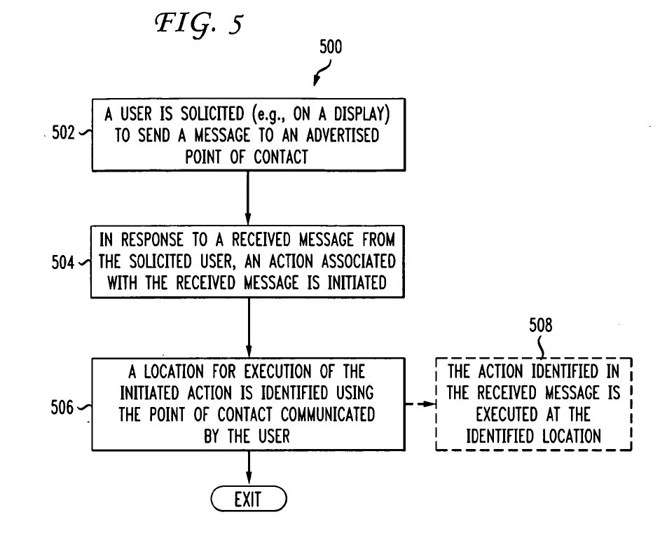

FIG. 5 depicts a flow diagram of a method 500 for using message service for control and interaction in a content distribution environment in accordance with an embodiment of the present invention. The method of FIG. 5 begins at step 502 in which a user is solicited, for example on a nearby display, to respond, if interested, to the solicitation using a message service and an advertised point of contact. The method 500 then proceeds to step 504.

At step 504, in response to a received message from the solicited user, an action associated with the received message is initiated. For example and as described above, the user can be a shopper that sees a message on a display in proximity that displays an advertisement that instructs the shopper to send a text message to a specified number for more information on an advertised product and the user can send such a message. In an alternate embodiment, the user can be a technician, who can use the messaging capabilities of the embodiments of the present invention for configuration purposes, verification of installation or for trouble shooting. For example, if a technician wishes to communicate and interact with an appropriate server, a message can be communicated to the server and the server can respond with a failure code if any error occurs during processing of the request. The method 500 then proceeds to step 506.

At step 506, a location for execution of the initiated action is identified using the point of contact communicated by the user. The action can then be performed. For example, in one embodiment of the present invention, the action can include presenting additional advertising information on a product in a display in close proximity to a user as requested in the user's message. In an alternate embodiment of the present invention, the action can include presenting a failure code(s) in a display in close proximity to a technician if any errors exist in the system as requested in the technician's message. That is, in accordance with the present invention, the action can include any of the above described actions or any other actions that can be accomplished using the messaging capabilities of the various embodiments of the present invention. The method 500 can then be exited. In alternate embodiments of the present invention, the method 500 can further optionally include step 508, during which the action identified in the received message is executed at the identified location.

Having described various embodiments for a method and system for using message services, such as short-message service or multimedia-message-service (SMS/MMS) messages, for control and interaction within a content distribution environment (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention. While the forgoing is directed to various embodiments of the present invention, other and further embodiments of the invention may be devised without departing from the basic scope thereof.

1. A method for using a message service for communication in a content distribution environment, comprising:
soliciting a response from a user, said user instructed to respond using a message service and an advertised point of contact;
in response to a received message, initiating an action associated with said received message; and
identifying a location for execution of said initiated action using said point of contact communicated by said user.

2. The method of claim 1, further comprising executing said action at the identified location.

3. The method of claim 1, wherein said solicitation is presented on at least one display in a location proximate the user.

4. The method of claim 1, wherein said message service comprises short-message service or multimedia-message-service (SMS/MMS) messages.

5. The method of claim 1, wherein said advertised point of contact comprises a unique contact number to which messages are to be sent, the unique contact number being used to identify at least one display in close proximity to the user.

6. The method of claim 1, wherein said advertised point of contact comprises a unique code which is used to identify at least one display in close proximity to the user.

7. The method of claim 1, wherein said solicitation includes a message on a display in an advertising environment informing a viewer that if the viewer wants additional information on an advertised product to send a message to a point of contact advertised on the display.

8. The method of claim 7, wherein said message comprises a text message and said advertised point of contact comprises a contact number to which the text message is to be sent.

9. The method of claim 1, further comprising communicating a return message to a user in response to the received message.

10. The method of claim 9, wherein said return message is a text message which is communicated to a device used by the user to communicate the received message.

11. The method of claim 1, wherein said action comprises displaying additional advertising content on a display in proximity to the user.

12. The method of claim 1, wherein said action comprises displaying error codes if an error exists in the content distribution environment.

13. The method of claim 1, wherein said action comprises making configuration adjustments to content playout devices in the content distribution environment.

14. The method of claim 13, wherein configuration adjustments comprise at least one of a volume level adjustment, channel selection and media selection.

15. A system for using a message service for communication in a content distribution environment, comprising:
at least one display for displaying content;
at least one communication means for communicating messages using a message service;
a server configured to perform the steps of:
soliciting a response from a user, said user instructed on at least one display to respond using at least one communication means via said message service and an advertised point of contact;
in response to a received message, initiating an action associated with said received message; and
identifying a location for execution of said initiated action using said point of contact communicated by said user.

16. The system of claim 15, wherein said at least one communication means comprises at least one mobile communications device.

17. The system of claim 16, wherein said at least one mobile communications device comprises at least one cell phone and said messages comprise text messages.

18. The system of claim 15, wherein said at least one communication means comprises a mobile communications system.

19. The system of claim 18, wherein said mobile communications system comprises:
at least one cell tower for receiving and forwarding messages;
a cellular carrier for receiving messages from said at least one cell tower and configuring received messages for transmission over an internet to the server.

20. The system of claim 15, wherein said at least one communication means comprises at least one femtocell.

21. The system of claim 15, further comprising:
a wide area network for receiving action instructions from said server and communicating said instructions to a media server; and
said media server for receiving said action instructions and causing the performance of actions associated with said received action instructions.

22. The system of claim 15 further comprising a playout device located proximate the user for executing said action at the identified location.
